(19) United States
(12) Patent Application Publication
(10) Pub. No.: US 2025/0258105 A1
(43) Pub. Date: Aug. 14, 2025

(54) ION DETECTION WITHOUT OPTICAL INTERFERENCE FROM SAMPLES

(71) Applicant: VIRGINIA COMMONWEALTH UNIVERSITY, Richmond, VA (US)

(72) Inventors: Xuewei WANG, Richmond, VA (US); Renjie WANG, Richmond, VA (US); Nasrin Ghanbari GHALEHJOUGHI, Richmond, VA (US)

(21) Appl. No.: 18/854,795

(22) PCT Filed: Apr. 18, 2023
(86) PCT No.: PCT/US2023/065882

§ 371 Date: Oct. 7, 2024

Related U.S. Application Data
(60) Provisional application No. 63/331,929, filed on Apr. 18, 2022.
(60) Provisional application No. 63/334,240, filed on Apr. 25, 2022.

(51) Int. Cl. G01N 21/80; G01N 21/77

(52) U.S. Cl. CPC G01N 21/80; G01N 2021/7766; G01N 2021/7786

(57) ABSTRACT

Devices to detect analytes (e.g., charged species such as ions) in samples are provided as are methods for their use. The devices comprise a tube or container comprising a water-immiscible sensing oil phase comprising at least one sensing chemical that binds the at least one analyte. The tube further receives an aqueous sample. Upon mixing of the two immiscible phases, the analyte partitions into the oil phase and binds to the sensing chemical, delectably changing the optical properties of the sensing chemical (or of an associated reporter molecule). Detection of the changes permits quantification of the amount or concentration of analyte in the sample without optical interference from the sample. The devices are suitable for home use and other decentralized settings.

### CROSS-REFERENCE TO RELATED APPLICATIONS

This application claims benefit of Untied States provisional patent applications 63/331,929 filed Apr. 18, 2022 and 63/334,240 filed Apr. 25, 2022.

### BACKGROUND OF THE INVENTION

### Technical Field

The invention generally relates to improved biphasic devices for analyte detection in biological samples and methods of their use.

### Description of Related Art

Blood testing is routinely performed for medical diagnostics as blood carries valuable information on health status. Although blood sampling is more invasive than other body fluids such as urine, sweat, saliva, and tear, blood composition is well regulated and has confirmed correlation with many health conditions. Analysis of blood composition has its own challenges due to properties like dark color, high turbidity, and high protein and cell contents. In central laboratories, blood samples usually undergo pretreatment procedures such as coagulation, centrifugation, dilution, deproteination, and cell lysis before instrumental analysis is performed. Nearly all major blood constituents such as ions, metabolites, lipids, drugs, proteins, nucleic acids, and cells can now be readily analyzed. As a complement to laboratory diagnosis, point-of-care testing (PoCT) has been rapidly growing over the past decades because it features reduced turnaround times and allows for on-site medical interventions without delay. Blood analyses in PoCT devices primarily rely on sensor technologies that directly read blood composition without multi-step assay procedures. A remarkable example is benchtop and handheld blood gas/electrolyte/metabolite analyzers that have gained great commercial success in hospitals. Most blood analyzers use electrochemical sensors such as ion-selective electrodes and chemically modified electrodes as these sensors are intrinsically not susceptible to color and turbidity of blood. Optical sensors based on fluorescence or absorbance can be used for direct hemoglobin tests but need built-in plasma separation, significant dilution, and/or inner filter effect correction for other analytes due to the optical interference of hemoglobin.

At-home blood testing is an emerging trend in PoCT as it allows patients to frequently monitor their health conditions without visiting hospitals or testing facilities. Blood testing at home has specifical requirements compared to tests with healthcare professionals. First, the required blood volume needs to be low (ideally 10 μL or below) as patients can only collect capillary blood. Second, the operation needs to be as simple as possible so that all patients can use these devices with no or minimal training. Third, at-home devices need to be more affordable than PoCT devices in clinics and hospitals. Blood glucose meters are obviously the most successful at-home sensors and have revolutionized the management of diabetes. Based on similar electrochemical sensing principles on enzyme-modified electrodes, other analytes such as lactate, uric acid, urea, creatinine, cholesterol, and ketones can also be detected at home from fingerprick blood samples. Lateral flow immunoassay strips are also commercially available for qualitative or quantitative analysis of blood components including antibodies (e.g., autotest VIH® for HIV antibody) and proteins (e.g., A1CNOW®⁺ for hemoglobin H1Ac).

However, there is an urgent need to measure many other analytes at home. Hypoparathyroidism patients suffer from a deficiency of parathyroid hormone and have abnormally low blood Ca²⁺ concentrations. To reduce the risk of various acute and chronic complications, including death, their Ca²⁺ levels need to be adjusted by administration of supplemental calcium (Journal of Clinical Endocrinology & Metabolism. 2016, 101(6), 2273-2283; Clinical endocrinology. 2019, 90(2), 285-292.). Because there is no “one-size-fits-all” dosing for hypoparathyroidism, the therapy must be guided by blood Ca²⁺ assessments multiples times per week. Patients with conditions including chronic kidney disease, heart failure, diabetes mellitus, and atherosclerotic cardiovascular disease are at an increased risk of hypokalemia (low potassium) and hyperkalemia (high potassium) (International journal of cardiology. 2017, 245, 277-284.). Because many life-threating dyskalemia incidences lack obvious symptoms, timely and frequent blood K⁺ monitoring is crucial to inform medical practices and decrease the rates of hospitalization and mortality. Daily Na⁺ monitoring guides fluid intake and allows patients with diabetes insipidus to maintain normal blood Na⁺ levels, therefore reducing hospitalizations and improving patient outcomes (Journal of the Endocrine Society. 2019, 3(5), 882-886; Anales de Pediatría. 2020, 93(4), 262-264.). In addition to Ca²⁺, K⁺, and Na⁺ adequate monitoring of other ions such as Li⁺ and Mg²⁺ will also benefit the management of diseases such as bipolar disorder and depression. Therefore, at-home electrolyte monitors have the potential to empower patients to self-monitor and self-manage a variety of chronic diseases.

Electrolyte measurements in whole blood have been routinely performed in hospitals for decades via benchtop instruments such as blood analyzers from Radiometer, Instrumentation Laboratory, and Nova Biomedical as well as handheld blood analyzers including i-STAT from Abbott and Epoc® from Siemens. Most blood electrolyte analyzers employ ionophore-based ion-selective electrodes, a well-established category of electrochemical sensors. All commercial blood electrolyte analyzers require on-site calibration via automated fluidic systems, rendering the device complicated and costly. More importantly, even the handheld analyzers using miniaturized electrodes require ˜100 μL blood, which is much larger than the ˜10 μL volume of a blood drop collected from a finger prick. As a result, blood electrolyte analyzers have not been widely implemented in at-home settings despite the well-known needs. Ionophore-ion-selective optodes are the optical counterpart of ion-selective electrodes. Both techniques employ a water-immiscible matrix containing hydrophobic sensing chemicals to detect ions in a surrounding aqueous sample. Compared to the success of ion-selective electrodes, ion-selective optodes have been rarely used for whole blood analysis because of optical interference. The classical formats of ion-selective optodes include thin films and micro/nanoparticles, neither of which is suited for blood analysis since detection of the absorbance or fluorescence of optodes is prohibited when optodes are covered by blood samples. Ion-selective optodes based on upconverting nanoparticles reduce the background absorbance and autofluorescence in blood, but the whole blood test was only demonstrated for 10-fold diluted blood with a standard addition protocol (Anal. Chem. 2013, 85, 5, 2617-2622). The Xie group designed nanoparticle optode-loaded hydrogels to detect blood electrolytes using the diffusion distance of electrolytes (ACS Sens. 2017, 2, 10, 1410-1414; Sensors and Actuators B: Chemical Volume 319, 15 Sep. 2020, 128300). However, the accurate identification of diffusion boundary is not easy and the storage stability of hydrogels is a concern in real-world applications.

Traditional ion-selective optodes employ semi-solid matrices containing sensing chemicals to extract analyte ions from aqueous samples. Ions can also be extracted into a water-immiscible liquid that dissolves hydrophobic sensing chemicals, which is a liquid-liquid extraction process. In contrast to conventional 2D optode films, a segment of organic liquid can serve as a 3D optode that can be interrogated from one side without optical interference from the sample. The Bakker group used bulk solutions of dichloroethane as the opotodes for titrimetric detection of electrolytes in bulk aqueous samples (ACS Sens. 2017, 2, 4, 606-612). However, blood was not tested and the titration protocol in the presence of magnetic stirring cannot be applied outside laboratories. Parallel flow microfluidics was examined for liquid-liquid ion extraction and optical ion detection (Anal. Chem. 2001, 73, 6, 1382-1386 Analytical Chemistry 2001, 73, 22, 5551-5556), but biological samples were not tested probably because the liquid-liquid interface is unstable with these samples.

Oil stream in droplet microfluidics was recently functionalized with hydrophobic sensing chemicals to create oil segment-based optodes (Angewandte Chemie International Edition, 2019, 58 (24), 8092-8096; Analytical Chemistry, 2021, 93 (40), 13694-13702). Since the oil segments and aqueous droplets are spatially and temporally separated, the optode interrogation at a perpendicular angle to the microfluidic channel does not suffer from optical interference from the aqueous sample. Correspondingly, electrolyte measurements in nanoliters of whole blood with 2-fold dilution or without dilution are realized. However, these microfluidic systems comprising pumps, chips, microscopes, and laser-induced fluorescence detection setups are obviously unsuitable for home use.

Pending US patent application 20200316605 discloses droplet microfluidic technology that utilizes an oil phase comprising sensing molecules. The oil phase is used to segment samples into droplets and provide oil segments that are highly selective chemical sensors for adjacent aqueous droplets. However, this technology is specific for biphasic ion sensing in microfluidics with high-velocity flow. Thus, a large number of oil and sample segments must be created (e.g., thousands per minute), the technique is very complicated and is not at all suited for home use.

There is a need for improved, reliable methods of and devices for detecting ions in samples, especially biological samples such as blood, that are adapted for patient use, e.g., for small personal point-of-care testing (PoCT) devices for use at home.

### SUMMARY OF THE INVENTION

Other features and advantages of the present invention will be set forth in the description of invention that follows, and in part will be apparent from the description or may be learned by practice of the invention. The invention will be realized and attained by the compositions and methods particularly pointed out in the written description and claims hereof.

Improved biphasic devices for analyte detection in samples, generally aqueous samples) and methods of their use are provided. The devices comprise a tube comprising i) a sensing liquid (also referred to herein as “oil phase”) that is not miscible with the sample and which comprises at least one sensing chemical capable of binding the at least one analyte and ii) optionally, a dilution buffer, e.g., an aqueous buffer that is miscible with a sample comprising at least one analyte of interest (or suspected of comprising at least one analyte of interest). After uptake of an aliquot of the sample into the tube, the sample, optional dilution buffer and the sensing oil are mixed and analytes from the sample partition into the sensing oil and bind to the sensing chemical. Other components of the sample (e.g., erythrocytes with red color and bilirubin with yellow color) that might otherwise interfere with optical detection remain in the aqueous phase. Binding of the analytes to the sensing chemical changes the optical properties thereof in a detectable manner, either via the sensing chemical itself, or in concert with an optical reporter molecule that is also present in the sensing oil. This permits quantification of the amount of analyte in the sensing oil (and by correlation, the amount of analyte in the sample) without optical interference.

It is an object of this invention to provide a system for detecting one or more analytes in a sample, comprising: a tube or container in which the sample may be added, wherein the tube is configured to permit application of a suction within a volume defined by the tube or container; a sensing oil that is within or addable to the tube or container, wherein the sensing oil is immiscible with the sample; at least one molecule that selectively binds to at least one analyte, wherein the at least one molecule is dissolved or dispersed in the sensing oil, and, optionally, a buffer that is within or addable to the tube or container, wherein the buffer is miscible with the sample. In some aspects, the system further comprises at least one reporter molecule dissolved or dispersed in the oil, wherein the at least one reporter molecule is activated by the at least one molecule selectively binding to the at least one analyte in the sample. In other aspects, the system further comprises a suction source connectable to the tube or container.

Also provided is a device for detecting at least one analyte in a sample, comprising a tube comprising a first open end that is configured to receive a sample; a second open end that is configured to be attached to a source of suction; a sensing oil that is immiscible with the sample and which comprises at least one sensing molecule that binds to the at least one analyte, and, optionally, i) at least one optical reporter molecule, and/or ii) at least one ion exchanger; and a source of suction configured to attach to the second open end of the tube. In some aspects, the device further comprises dilution buffer. In other aspects, the tube is a pipette tip, capillary tube or microfabricated channel. In further aspects, a volume of the dilution buffer ranges from 0.1 μl to 10 ml. In yet further aspects, a volume of the oil phase ranges from 0.1 μl to 10 ml. In other aspects, the at least one sensing molecule is an ionophore or comprises an ion recognition unit. In additional aspects, the at least one optical reporter molecule is a pH indicator such as a Nile blue derivative or a cationic dye such as methylene blue. In yet other additional aspects, the at least one ion exchanger is a tetraphenylborate derivative or a quaternary ammonium compound (a cation, which is the quaternary ammonium, and an ion like chloride, nitrate, etc. which forms a salt).

Also provided is a system comprising a device of any of claims 4-11 (such as a device for detecting at least one analyte in a sample, comprising a tube comprising a first open end that is configured to receive a sample; a second open end that is configured to be attached to a source of suction; a sensing oil that is immiscible with the sample and which comprises at least one sensing molecule that binds to the at least one analyte, and, optionally, i) at least one optical reporter molecule, and/or ii) at least one ion exchanger; and a source of suction configured to attach to the second open end of the tube); a source of suction; and a reader device configured to detect the color, absorbance, or fluorescence of the sensing oil and determine a concentration of the at least one analyte based on the color, absorbance, or fluorescence of the sensing oil. In some aspects, the source of suction is a stepper motor-based device. In some aspects, the stepper motor-based device is an electronic pipette or a syringe pump. In further aspects, the reader device is a camera, photometer, spectrophotometer or fluorometer. In yet further aspects, the camera is a part of a mobile electronic device selected from the group consisting of a cell phone, a smart phone, a personal computer, and a personal digital assistant. In additional aspect, the system further comprises a light source configured to illuminate the tube.

Also provided is a method of detecting at least one analyte in a sample, comprising: aspirating the sample into the tube of any of claims 4-9, (such as a device for detecting at least one analyte in a sample, comprising a tube comprising a first open end that is configured to receive a sample; a second open end that is configured to be attached to a source of suction; a sensing oil that is immiscible with the sample and which comprises at least one sensing molecule that binds to the at least one analyte, and, optionally, i) at least one optical reporter molecule, and/or ii) at least one ion exchanger; and a source of suction configured to attach to the second open end of the tube, and which optionally comprises dilution buffer); within the tube, mixing the sample with the sensing oil according to a protocol that permits the at least one analyte to partition into the sensing oil and bind to the at least one sensing molecule; and detecting an optical property change that occurs in the at least one sensing molecule, or, optionally, in the at least one optical reporter molecule, upon binding of the at least one analyte to the at least one sensing molecule. In some aspects, the optical property change indicates a quantity of the at least one analyte bound to the at least one sensing molecule. In further aspects, the sample is a biological sample. In additional aspects, the biological sample is blood, tears, sweat, saliva, urine, interstitial fluid, cerebrospinal fluid, milk, serum or plasma. In yet further aspects, the water-immiscible oil is one or more of at least one plasticizer and at least one plant oil. In additional aspects, the at least one sensing molecule is an ionophore or comprises an ion recognition unit. In other aspects, the mixing protocol comprises a plurality of cycles of pushing and pulling the liquid in the tube. In further aspects, the plurality of cycles of pushing and pulling ranges from 1 to 5000. In some aspects, the reporter molecule is a chemical with absorbance or fluorescence in the UV-visible range. In further aspects, the at least one analyte is an ion or a small molecule. In yet further aspects, the ion is at least one of a proton, K⁺, Na⁺, Li⁺, Ca²⁺, Mg²⁺, Pb²⁺, Cd²⁺, Cu²⁺, Cr²⁺, Ag⁺, Hg²⁺, Zn²⁺, Cl⁻, SO₄²⁻, CO₃²⁻, nitrate, nitrite, creatinine, or a drug that is ionic at the applied pH (the pH of the sample or sample plus dilution buffer aqueous solution)

### BRIEF DESCRIPTION OF THE DRAWINGS

FIGS. 1A and B. A, exemplary pipette tip containing sensing oil; B, exemplary pipette tip containing sensing oil after sample has been aspirated into the pipette tip.

FIG. 2A-C. Three exemplary formats of an exemplary tube of the device, in this case a pipette tip. All formats are shown both before and after sample addition. A, Format 1; B, Format 2; C, Format 3.

FIG. 3A-C shows the relative positions of an aqueous sample and the sensing oil and color changes: A, before mixing, B, after initial, limited mixing, and C, after more mixing. The position shown in B is accomplished via 10 cycles of pulls and pushes with a faster pulling speed. The switched position of the sensing oil and the aqueous sample in C is accomplished via 10 more cycles of pulls and pushes with a faster pushing speed after B. This experiment used Format 1. More mixing steps using unequal pushing and pulling speeds may be needed to alter the relative position of the sensing oil and the aqueous sample for more times and to allow the full mass transfer between two phases.

FIG. 4A-C shows schematic exemplary aspects of ion extraction from a sample into a sensing oil when the sample contains no Ca²⁺ (A), a low concentration of Ca²⁺ (B), and a high concentration of Ca²⁺ (C). The sensing oil (dioctyl sebacate) contains chromoionophore, ion exchanger, and calcium ionophore II at a molar ratio of 0.5 to 1 to 6. In the absence of Ca²⁺, the chromoionophore is protonated due to extraction of protons from the sample into the oil. When the concentration of Ca²⁺ is below the lower end of the clinically relevant range, the chromoionophore is still protonated because extraction of protons from the sample into the oil are still allowed. When the concentration of Ca²⁺ is above a threshold concentration, the chromoionophore can no longer be fully protonated and the oil color is different. Therefore, the oil sensor responds to Ca²⁺ when its concentration is in the clinically relevant range. The molar ratio of three sensing chemicals may be adjusted to tune the response range.

FIG. 5. Color of sensing oil after being exposed to and mixed with aqueous solutions containing 1.0 to 2.0 mM CaCl₂). Hue of the oil segment is labelled on the bottom of the picture.

FIG. 6. Color of the sensing oil after being exposed to a drop of blood containing CaCl₂).

FIG. 7. Color of sensing oil after being exposed to and mixed with aqueous solutions containing 3-7 mM KCl. Hue of the oil segment is labelled on the bottom of the picture.

### DETAILED DESCRIPTION

Methods and devices for detecting analytes such as ions and small, charged molecules in liquid samples are described herein. The devices utilize at least a liquid sensing oil phase that contains at least one ion sensing chemical that either by itself, or in concert with an optical reporter molecule that is also present in the sensing oil, exhibits a detectable change in optical properties when bound to an analyte of interest. The devices may also include a liquid dilution buffer which is miscible with a sample to be tested (the sample contains or may contain an analyte or analytes of interest).

Accordingly, the devices, as provided by a manufacturer, comprise: i) a water-immiscible “sensing oil” phase that is immiscible with an aqueous sample, both before and after mixing therewith and (ii) optionally a water-miscible first liquid phase (usually an aqueous phase) or “dilution buffer” that is miscible with a sample of interest, e.g., a sample comprising, or suspected of comprising, at least one analyte of interest. The sensing oil comprises one or more sensing chemicals that bind the at least one analyte of interest. When the two phases are in contact, analyte molecules in the dilution buffer partition into the sensing oil and bind to the one or more sensing chemicals. Notably, components of the sample other than the analytes, and which might interfere with optical sensing, do not appreciably partition into the sensing oil, i.e., they remain in the aqueous phase. The sensing chemical itself has optical properties (e.g., color, fluorescence, etc.) that change upon the binding of an analyte and can be detected. Detection of a color change in the sensing oil thus indicates the presence of bound analytes and confirms that the analyte(s) of interest was/were present in the sample. Alternatively, sensing molecules which have bound analytes may then associate with a “reporting” molecule in the sensing oil and change the optical properties of the reporting molecule in a detectible manner. Either way, the optical changes are detected/measured/quantitated and correlate with (are indicative of, indicate, etc.) the amount of analyte that is bound, and hence with the amount of analyte that was originally in the sample. Significantly, only optical changes in the oil phase are measured and the oil phase is spatially separated from the aqueous phase. Therefore, optical interference from the sample or dilution buffer (due to color, turbidity, etc.) does not occur, which differs from optical chemical sensing in a single liquid phase. The devices are well-suited for small scale, home use, point-of care (PoCT) analyses. This system constitutes a new format of organic liquid-based optodes for electrolyte measurements in resource-limited settings, including patient homes.

This platform is suitable for electrolyte monitoring e.g. blood by patients at home because 1) only a few ∞l of blood are required and can be readily obtained from a finger prick; 2) the sensing system, including a disposable sensor tube, the motor which drives mixing, and the camera are each compact and affordable; and 3) no on-site calibration is needed as the variability among different liquid sensors is negligible, which is in contrast to most solid sensors.

### Definitions

A chromoionophore is an ionophore that changes its optical properties in the visible spectrum depending on the state of complexation. Chromoionophores for use in sensors are typically proton-sensitive dyes that change absorbance (and fluorescence in many cases) depending on the degree of protonation, although chromoionophores that change absorbance in response to other ions can also be used. The chromoionophores are preferably highly lipophilic to inhibit leaching into the dilution suffer and/or sample.

As used herein, the term “detectable signal” includes detecting changes in fluorescence, changes in luminescence, changes in transmission, changes in color, distribution of light energies arranged in order of wavelength, etc.

As used herein, the phrase “dilution buffer” refers to a liquid (fluid) that is immiscible with the sensing oil described herein, but which can mix with (is miscible with) a sample of interest. The dilution buffer is typically an aqueous liquid phase comprising a buffering agent or agents. The dilution buffer may further contains other water-soluble chemicals with other functions such as converting complexed and bound cations to free cations.

“Electrolytes” are substances that have a natural positive or negative electrical charge when dissolved in water. They help regulate the body's chemical reactions and maintain the balance between fluids inside and outside your cells, etc. and represent important indicators for the diagnosis of a wide range of medical conditions and diseases.

As used herein, the term “means for detecting” or “detecting means” refers to an apparatus for monitoring a signal and/or displaying a signal value, e.g., to monitor the progress and/or to determine a result of an assay. A detection means may include a detection channel and a means for evaluation of a signal value. A signal may be detected and/or evaluated by an observer visually or by a machine equipped with a detection means such as a camera, photometer, spectrophotometer, fluorometer, luminometer, photomultipliertube, photodiode, nephlometer, photon counter, voltmeter, ammeter, pH meter, capacitative sensor, radio-frequency transmitter, magnetoresistometer, or Hall-effect device. Preferably, herein a detecting means comprises a camera, a photometer, a spectrophotometer, or a fluorometer. Magnifying lenses, optical filters, colored fluids, and labeling may be used to improve detection and interpretation of a signal. Means for detection may also include the use of “labels” or “tags” such as, but not limited to dyes such as chromophores and fluorophores, radio frequency tags, plasmon resonance, spintronic, radiolabel, Raman scattering, chemoluminescence, or inductive moment as are known in the art. Fluorescence quenching signals are also included. A variety of substrate and product chromophores associated with biochemical enzyme assays are also well known in the art and, in some embodiments, provide a means for amplifying a signal so as to improve sensitivity of detection. Detection means or systems are optionally qualitative, quantitative, or semi-quantitative. Visual detection is preferred for its simplicity; however, detection means can involve visual detection, machine detection, manual detection, or automated detection.

As used herein, the term/phrase “oil” or “oil phase” or “sensing oil” refers to a liquid (fluid) that is immiscible with the dilution buffer and sample described elsewhere herein and which comprises (dissolved or suspended therein) at least one type of sensing molecule.

An optode or optrode is an optical sensor device that optically measures a specific substance usually with the aid of a chemical transducer.

Ion exchangers mediate the reversible interchange of one kind of ion present between the two immiscible phases. Ion exchangers are either cation exchangers, which exchange positively charged ions (cations), or anion exchangers, which exchange negatively charged ions (anions). Ion exchangers are preferably hydrophobic so that they are dissolved in the oil phase.

An ionophore is a lipophilic compound that binds to an ion and facilitates transmission of the ion into a lipophilic environment (e.g., the sensing oil of the present devices) and retention of the ion in the lipophilic environment. Ionophores may be cation-selective or anion-selective.

A “sensing molecule” as used herein refers to a molecule that specifically or selectively binds charged species such as ions, small molecules, or serves other functions in the sensing process, e.g., ion exchange and optical reporting. Examples of sensing molecules include chromoionophores, ionophores, and ion exchangers, etc.

As used herein, a small-molecule drug is an organic compound with a molecular weight below about 1000 daltons, such as below about 900 daltons, that affects a biologic process.

As used herein, the term “visible spectrum” or “color” refers to light radiation that contains one or more wavelengths of from approximately 360 nm to approximately 800 nm.

### Sensing Liquid (Oil)

The “sensing oil” that is present in the devices described herein is a water-immiscible phase that is a liquid at room temperature. In some aspects, the sensing oil is or comprises at least one organic solvent that is immiscible with (not miscible with, non-miscible with) and/or is essentially immiscible with the dilution buffer and/or sample described herein. Mixtures of oils and/or organic solvents may be used. “Essentially immiscible with the dilution buffer and/or sample” means in this context that under the given reaction conditions (especially under the given reaction temperature) at most 10 g, preferably at most 5 g of the sensing oil are soluble in 100 g of the dilution buffer and/or sample or, vice versa, that is that at most 10 g, preferably at most 5 g of the dilution buffer and/or sample are soluble in 100 g of this oil phase.

The volume of sensing oil in a tube of the device generally ranges from about 0.1p l to about 10 ml, i.e. about 0.1, 1.0, 10, 25, 50, 75, 100, 150, 200, 250, 300, 350, 400, 450, 500, 550, 600, 650, 700, 750, 800, 850, 900, 950 or 1000 μl (1 ml), or from about 1 to about 10 ml, such as about 1.0, 2.0, 3.0, 4.0, 5.0, 6.0, 7.0, 8.0, 9.0, or 10.0 ml; including all decimal fractions in between these ranges, to the nearest 0.1 decimal place, e.g., about 0.1, 0.2, 0.3 μl, and so on up to about 9.5, 9.6, 9.7, 9.8, 9.9, or 10.0 ml.

Preferably, the sensing oil has a high boiling point (for example, greater than 100° C.) that prevents its fast evaporation and possible hazard to users of the device. Preferably, the sensing oil does not cause significant hemolysis (for example, less than 5%) when the sample is blood.

Examples of preferred organic solvents that are used as sensing oils include but are not limited to: plasticizers, cooking and/or edible medicinal oils, and industrial oils, as well as aliphatic hydrocarbons, cycloaliphatic hydrocarbons, aromatic hydrocarbons, amines, esters, ethers, ketones, and nitrated or chlorinated hydrocarbons. The sensing oil may be any plasticizer, any plant oil, mineral oil, or silicone oil.

Exemplary plasticizers include but are not limited to: dioctyl sebacate, 2-nitrophenyl octyl ether, polyethylene glycol, epoxidized soybean oil, isosorbide ester, isosorbide diester, diethyl succinate, dimethyl glutarate, dimethyl adipate, succinic acid, dimethyl, glyceryl oleate, glyceryl linoleate, glyceryl palmitate, diethyl adipate, sorbitan distearate, glyceryl stearate, sucrose distearate, rape seed methyl ester, diethylhexyl adipate, sorbitan tristearate, diisopropyl adipate, succinate, dibutyl sebacate, diethyl phthalate, triethyl citrate, tributyl citrate, triacetin, acetylated monoglycerides, phthalate esters, tri(ethylene glycol) bis(2-ethylhexanoate), tri(ethylene glycol) bis(n-octanoate), tetra(ethylene glycol) bis(2-ethylhexanoate), tetra(ethylene glycol) dihexanoate, di(propylene glycol) bis(2-ethylhexanoate); tri(propylene glycol) bis(2-ethylhexanoate), and tri(propylene glycol) dihexanoate, castor oil, and the like.

Other examples of liquids suitable for use as the sensing oil are described in International Patent Application No. PCT/US2006/047486 and in International Patent Application No. PCT/US2008/072604, each of which is incorporated herein by reference.

Exemplary plant (e.g., cooking) and/or edible medicinal oils that are employed include but are not limited to: olive oil, canola oil, peanut oil, avocado oil, sunflower oil, safflower oil, corn, soybean, and other vegetable oils, coconut oil, acai oil, blackcurrant seed oil, borage seed oil, evening primrose oil, etc. Various nut oils may also be used such as almond, cashew, hazelnut, macadamia, pecan, pistachio and walnut oil.

Exemplary industrial oils that are employed include but are not limited to see oils such as canola, corn, cottonseed, soybean, sunflower, safflower, grapeseed, palm oil, and rice bran oil.

Exemplary aliphatic hydrocarbons that are employed include but are not limited to: pentane, hexane, heptane, octane, petroleum ether, and squalene.

Exemplary cycloaliphatic hydrocarbons that are employed include but are not limited to: cyclohexane and cyclooctane.

Exemplary aromatic hydrocarbons that are employed include but are not limited to: benzene, toluene and xylenes.

Exemplary ethers that are employed include but are not limited to: aliphatic ethers, such as diethylether, dipropylether, dibutylether, methyl-tert-butylether and methyl-isopropylether.

Exemplary water-immiscible ketones that are employed include but are not limited to: cyclohexanone and isophorone.

Exemplary esters of aliphatic monocarboxylic acids that are employed include but are not limited to: ethylacetate, propylacetate, ethylpropionate and propylpropionate.

Exemplary chlorinated hydrocarbons that are employed include but are not limited to: chlorinated alkanes, such as dichloromethane, chloroform, tetrachloromethane, dichloroethylene and trichloroethylene.

Exemplary nitrated hydrocarbons that are employed include but are not limited to: polycyclic aromatic hydrocarbons.

In some aspects, the sensing oil used in the technology provided herein comprises other components such as a surfactant. In other aspects, the sensing oil does not comprise a surfactant, i.e., is a “surfactant-free” sensing oil.

### Sensing Molecules

The sensing oil that is employed is i) immiscible with the liquid phase that is employed in the methods and devices, and ii) is capable of dissolving, suspending or otherwise containing a uniform amount of at least one type of sensing molecule. In some aspects, one chemical is used as the molecular probe for the analyte. This chemical has a recognition site (receptor) to bind (specifically or selectively) to the analyte and an optical readout site (reporter). This analyte-binding chemical changes its optical properties (such as color, fluorescence, etc.) as the optical signal used for chemical measurements changes upon binding to the analyte extracted from the aqueous sample which has partitioned into the oil phase.

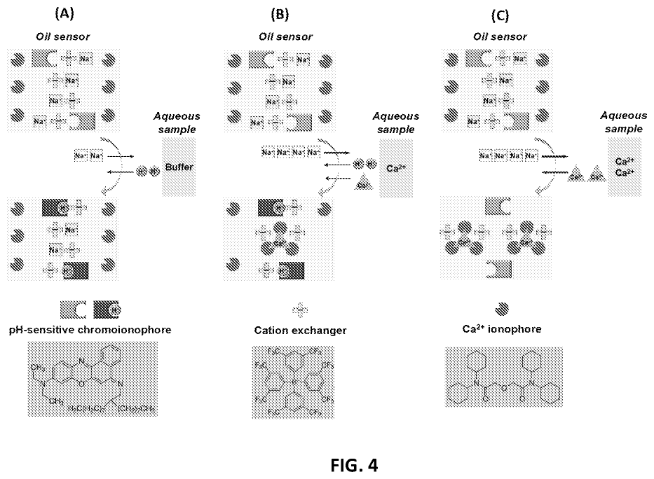

In other aspects, more than one sensing chemical (i.e., a plurality of sensing chemicals) is/are present in the sensing oil. The sensing molecules can be a dye that is a pH indicator or a cationic dye. Other sensing chemicals may include ion recognition elements that bind to specific ionic analytes and ion exchangers that facilitate the extraction of ionic analytes. One sensing chemical may have two or more functions including optical reporting, ion recognition, and ion exchange. An exemplary response mechanism is shown in FIG. 4, where the use of a pH indicator (pH-sensitive chromoionophore III) is the optical reporter, a calcium ionophore is the ion recognition element, and a cation exchanger facilitates calcium ion extraction. A combination of these three chemicals in the oil phase allows for optical detection of an ion in an aqueous sample.

The concentration of sensing molecule in the sensing oil generally ranges from about 1 nM to about 100 mM and is typically from about 0.1 mM to about 10 mM.

Examples of sensing molecules that are employed in this manner include but are not limited to:
I. Chromoionophores (pH indicators) such as one or more of: Nile blue, chromoionophore I (9-(diethylamino)-5-(octadecanoylimino)-5H-benzo[a]phenoxazine) designated ETH5249; chromoionophore II (9-dimethylamino-5-[4-(16-butyl-2,14-dioxo-3,15 ioxaeicosyl)phenylimino]benzo[a]phenoxazine) designated ETH2439 and having light absorbance peaks at 520 nm and 660 nm and a fluorescent emission peak at 660 nm; chromionophore III (9-(diethylamino)-5-[(2-octyldecyl)imino]benzo[a]phenoxazine), designated ETH 5350 and having light absorbance peaks at 500 nm and 650 nm and fluorescent emission peaks at 570 nm and 670 nm; chromoionophore IV (5-octadecanoyloxy-2-(4-nitrophenylazo)phenol), designated ETH2412; chromoionophore V (9-(diethylamino)-5-(2-naphthoylimino)-5H-benzo[a]phenoxazine); chromoionophore VI (4,5-dibromofluorescein octadecyl ester) designated ETH7075; chromoionophore XI (fluorescein octadecyl ester) designated ETH7061; [11-[(1-butylphenyl)oxy]-11-oxoundecyl-4-{[9-(dimethylamino)-5H-benzo[a]phenoxazine-5-ylidene]-amino}-benzenate]}; 2,4,5,7-tetraiodofluorescein octadecyl ester; and combinations thereof;
II: Cationic dyes such as rhodamine and rhodamine derivatives, methylene blue, thionine, thioflavin T, crystal violet, cyanines, hemicyanines, celestine blue, 2-[4 (dimethylamino)styryl]-1-methylpyridinium, toluidine blue O, 9-aminoacridine.
III. Cation and/or anion selective ionophores such as potassium ionophore I (valinomycin), potassium ionophore II (BB15C5, Bis[(benzo-15-crown-5)-4′-ylmethyl]pimelate), potassium ionophore III (2-Dodecyl-2-methyl-1,3-propanediyl bis[N-[5′-nitro(benzo-15-crown-5)-4′-yl]carbamate], BME 44), sodium ionophore IV (2,3:11,12-Didecalino-16-crown-5,2,6,13,16,19-Pentaoxapentacyclo[18.4.4.4^{7,12}.0^{1,20}.0^{7,12}]dotriacontane, DD-16-C-5), sodium ionophore VI (Bis[(12-crown-4)methyl]dodecylmethylmalonate, Dodecylmethylmalonic acid bis[(12-crown-4)methyl ester]), sodium ionophore X (4-tert-Butylcalix[4]arene-tetraacetic acid tetraethyl ester), sodium ionophore III (ETH 2120, N,N,N′,N′-Tetracyclohexyl-1,2-phenylenedioxydiacetamide), sodium ionophore I (ETH 227, N,N′,N″-Triheptyl-N,N′,N″-trimethyl-4,4′,4″-propylidynetris(3-oxabutyramide)), calcium ionophore II (N,N,N′,N′-Tetra[cyclohexyl]diglycolic acid diamide, N,N,N′,N′-Tetracyclohexyl-3-oxapentanediamide, ETH 129), calcium ionophore III (Calcium Ionophore A23187, Antibiotic A 23187, Calimycin), calcium ionophore IV (N,N-Dicyclohexyl-N′,N′-dioctadecyl-3-oxapentanediamide, N,N-Dicyclohexyl-N′,N′-dioctadecyl-diglycolic diamide, ETH 5234), calcium ionophore I ((−)-(R,R)—N,N′-Bis-[11-(ethoxycarbonyl)undecyl]-N,N′,4,5-tetramethyl-3,6-dioxaoctane-diamide, Diethyl N,N′-[(4R,5R)-4,5-dimethyl-1,8-dioxo-3,6-dioxaoctamethylene]bis(12-methylaminododecanoate), ETH 1001), calcium ionophore V (10,19-Bis[(octadecylcarbamoyl)methoxyacetyl]-1,4,7,13,16-pentaoxa-10,19-diazacycloheneicosane, K23E1), magnesium ionophore I (ETH 1117, Magnesium-ligand, N,N′-Diheptyl-N,N′-dimethyl-1,4-butanediamide), magnesium ionophore III (ETH 4030, N,N″-Octamethylene-bis(N′-heptyl-N′-methylmalonamide)), magnesium ionophore IV (ETH 7025, N,N′,N″-Tris[3-(heptylmethylamino)-3-oxopropionyl]-8,8′-iminodioctylamine), magnesium ionophore VII (4,13-[Bis(N-adamantylcarbamoyl)acetyl]-1,7,10,16,tetraoxa-4,13-diazacyclooctadecane, K22B5), magnesium ionophore VI (1,3,5-Tris[10-(1-adamantyl)-7,9-dioxo-6,10-diazaundecyl]benzene, ETH 5506), lithium ionophore IV (5-Butyl-5-ethyl-N,N,N′,N′-tetracyclohexyl-3,7-dioxaazelaic diamide, ETH 2137, N,N,N′,N′-Tetracyclohexyl(2-butyl-2-ethyltrimethylenedioxy)diacetamide), lithium ionophore VI (6,6-Dibenzyl-1,4,8-11-tetraoxacyclotetradecane, 6,6-Dibenzyl-14-crown-4), lithium ionophore VIII (N,N,N′,N′,N″,N″-Hexacyclohexyl-4,4′,4″-propylidynetris(3-oxabutyramide)), lead ionophore IV (tert-Butylcalix[4]arene-tetrakis(N,N-dimethylthioacetamide)), nitrate ionophore VI (9-Hexadecyl-1,7,11,17-tetraoxa-2,6,12,16-tetraazacycloeicosane), chloride ionophore IV (4,5-Bis-[N′-(butyl)thioureido]-2,7-di-tert-butyl-9,9-dimethylxanthene), and other commercially available chemicals such as monensin (Coban and Rumensin), lasalocid (Avatec and Bovatec), salinomycin (Bio-cox and Sacox), narasin (Monteban and Maxiban), maduramicin (Cygro), semduramicin (Aviax), laidlomycin propionate (Cattlyst), A23187 (Calbiochem).

In particular, Ca²⁺ ionophores are used such as: calcimycin (calcium ionophore A23187), ionomycin, synthetic calcium transporters such as the small alanine-derived peptides containing pyridyl-triazole motifs and decorated with hydrophobic alkyl chains as described by Saha et al., Bioconjugate Chem. 2022, 33, 11, 2143-2148; ETH-129; calcium ionophore II, calcium ionophore IV, calcium ionophore V, calcium ionophore VI, and calcium ionophore I.
IV. Cation and/or anion ion exchangers such as sodium tetrakis[3,5-bis(trifluoromethyl)phenyl]borate, potassium tetrakis[3,5-bis(trifluoromethyl)phenyl]borate, potassium tetrakis(4-chlorophenyl)borate, sodium tetrakis(4-chlorophenyl)borate, tridodecylmethylammonium chloride, tetradodecylammonium chloride, and tetradodecylammonium nitrate.

In some aspects, the sensing molecule itself does not exhibit detectable changes in optical properties when binding occurs but instead is associated with an optical reporter molecule that works in concert with the binding molecule. In this aspect, the binding molecule causes the reporter molecule, or the sensing oil as a whole, to exhibit changes in optical properties when binding to the sensing molecule occurs. In other words, the two chemicals work together to detect the analyte. One chemical is an analyte-binding chemical that binds to the analyte and the other chemical is a reporter molecule such as an optical reporter. In some aspects, the binding of the analyte with the analyte-binding chemical changes an optical property and/or concentration of the reporter chemical in the oil. As a result, the overall optical property of the oil phase is changed due to the extraction of the analyte from the sample.

In other aspects, the sensing molecule consists of the recognition unit (receptor) and the optical reporter unit (reporter). Upon binding of the receptor to the analyte, the reporter has an altered optical property such as color, absorbance, and fluorescence. The mechanism of the response is based on one or more of fluorescence quenching, photoinduced electron transfer, intramolecular, intramolecular charge transfer, fluorescence resonance energy transfer, and absorbance changing process. A few examples of theses sensing molecules are Arsenazo III for Ca²⁺, o-cresolphthalein complexone for Ca²⁺, sodium-binding benzofuran isophthalate-AM for Na⁺, potassium-binding benzofuran isophthalate-AM for K⁺. Any colorimetric or fluorescent molecular probes that can be dissolved in the oil phase may be used for this biphasic assay.

Examples of analyte-binding and reporter molecule pairs include but are not limited to: any combinations from groups I to IV as listed above. For example, a combination of chromoionophore, cation exchanger, and cation ionophore or a combination of cationic dye, cation exchanger, and cation ionophore in the oil phase allows for sensing of the corresponding cations.

The sensitivity (response slope) of the assay is enhanced by enhancing the extraction efficiency. To this end, chemicals with higher binding affinity toward the analyte ion are used and/or the ratio of the total amount of sensing chemicals to the total amount of analyte ions is increased.

### Dilution Buffer

Before use, the devices disclosed herein optionally also comprise a preloaded dilution buffer, usually an aqueous liquid phase. The dilution buffer is capable of receiving and mixing fully with (is miscible with) an aliquot of a sample that is tested/analyzed using the device. Thus, in some aspect, the sample is diluted by being drawn into the tube and mixing with dilution buffer already present in the tube.

Alternatively, in some aspects, the sample does not need to be diluted or is diluted in dilution buffer outside the tube and then diluted sample is drawn into the tube where it is mixed with the sensing oil. In this aspect, only the sensing oil is preloaded into the tube. In this case, the volume of prediluted sample that is taken into the tube generally ranges from about 1 μl to about 10 mL and is typically from about 2 μl to about 1 mL.

In some aspects e.g., when checking for water pollutants, it may be necessary to concentrate the sample prior to testing.

In aspects in which a dilution buffer is preloaded, the volume of the dilution buffer that is preloaded generally ranges from about 0.1 μl to about 10 ml and is typically from about 1 μl to about 1000 μl.

Exemplary dilution buffers that are employed include but are not limited to: saline; various aqueous based buffers such as phosphate (e.g., dihydrogen phosphate), HEPEs, MOPS, MES, BES, MOPSO, ACES, TAPS, Bicine, acetic acid with sodium acetate, ammonium hydroxide with ammonium chloride, citric acid with sodium citrate, carbonic acid with bicarbonate ion, KH₂PO₄ with K₂HPO₄, Tris buffers (e.g., Tris-HCl (Tris hydrochloride), Tris-EDTA (TE), Tris-buffered saline (TBS), Tris-acetate-EDTA (TAE), and Tris-borate-EDTA (TBE).

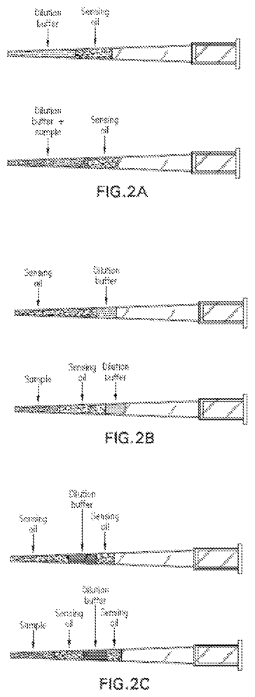

Exemplary arrangements or formats showing the relative positions or placements of preloaded dilution buffer and sensing oil within a tube of the device are shown in FIG. 2A-C.

In some aspects, the dilution buffer has a buffer capacity that eliminates pH variations of different samples (e.g., blood samples). In other words, the final pH of the diluted sample is precisely controlled to a specific value set by the dilution buffer. In some aspects, the dilution buffer also reduces the concentration of some interference species in real samples and minimizes their interference. The dilution buffer may also contain chemicals that dissociate the analyte from complexed and bound forms. These chemicals include but are not limited to Zn²⁺, Cu²⁺, Mg²⁺, and Ca²⁺. For example, Zn²⁺ can dissociate Ca²⁺ from proteins and convert bound Ca²⁺ to free Ca²⁺, which may facilitate the extraction of Ca²⁺ into the sensing oil.

Samples and Analytes that are Assessed

A wide variety of samples are assessed using the devices and methods disclosed herein. The samples that are assessed using the method are generally aqueous liquid samples. In some aspects, the samples are physiological samples, e.g. samples taken from an organism such as an animal or plant. In some aspects, the samples are obtained from a mammal such as a human. However, veterinary applications of this technology are not excluded, i.e., samples from non-human animals may also be assessed. Any liquid sample that can be mixed with the dilution buffer, or that is capable of being dissolved in a liquid that can be mixed with the dilution buffer, or that can be mixed with the sensing oil in a manner that permits extraction of analytes into the sensing oil, can be assessed.

Any aqueous sample with or without color and/or turbidity can be assessed. Examples of suitable physiological (body) samples include but are not limited to: tears, sweat, saliva, urine, interstitial fluid, cerebrospinal fluid, milk, serum, plasma, blood, intracellular fluid etc. However, the devices are not limited to the assessment of bodily fluids. Any type of fluid that contains or might contain at least one analyte of interest can be assessed. Examples include but are not limited to: extracellular fluids from organ-on-a chip, water such as tap water, rain water, water from naturally occurring or non-naturally occurring bodies of water (lakes, streams, oceans, reservoirs, etc.), aquariums, pools, waste water, industrial water, etc.

In addition, dry or gaseous samples or scrapings can be analyzed if they are first dissolved or extracted using an aqueous liquid, and samples taken e.g., by swabs can be analyzed by soaking the swab in a dilution buffer.

The analytes that are detected in samples that are assessed are generally ionic (negatively or positively charged) species at the pH at which the assay is conducted, although some species may bear both a negative and positive charge at some pH values (e.g., some amino acids, small molecules or drugs) or be uncharged. In some aspects, the analyte is an ionic species at the pH at which the assay is conducted. Examples include but are not limited to protons, K⁺, Na⁺, Li⁺, Ca²⁺, Mg²⁺, Pb²⁺, Cd²⁺, Cu²⁺, Cr²⁺, Ag⁺, Hg²⁺, Zn²⁺, Cl⁻, SO₄²⁻, CO₃²⁻, nitrate, nitrite, creatinine, and drugs that are ionic at the applied pH, i.e., the pH of the aqueous sample or the sample plus dilution buffer. Other examples include but are not limited to: vitamin C, steroids, aminoglycoside and beta-lactam antibiotics, various pollutants substances indicative of stroke, ischemia, or myocardial infarction such as a nitric oxide metabolite, aspirin, diphenhydramine, biological warfare agents, metals, carbonate, glutamate, aspartate, arginine, citrulline, acetylcholine, dopamine, etc.

In general, the volume of a sample that is taken up for analysis generally ranges from about 1-1000 μl, such as from about 1-100 μl, or from 1-50 μl, or from about 1-25 μl, or from about 1 to about 10 μl, e.g., about 1, 2, 3, 4, 5, 6, 7, 8, 9, or 10 μl or more, including all decimal fractions in between, e.g. from about 1.1, 1.2, 1.2, . . . to about 9.8, 9.9 and 10.0, and so on. Lower amounts of sample may also be used, e.g., from about 0.1 to about 1.0 μl, including all decimal fractions in between to the nearest 0.1 μl. Higher amounts of sample may also be used, e.g., from about 1 to 10 mL, including from about 1, 2, 3, 4, 5, 6, 7, 8, 9, or 10 ml, including all decimal fractions in between to 0.1 decimal point, e.g. 1.0, 1.1, 1.2 . . . to about 9.8, 9.9 or 10.0

When a dilution buffer is used, after a sample is loaded into preloaded dilution buffer, the total volume of dilution buffer plus sample generally ranges from about 0.2 μl-20 ml, such as from about 1 μl-2 ml, or from about 1-200 μl, or from about 1 to about 10 μl, e.g., about 1, 2, 3, 4, 5, 6, 7, 8, 9, or 10 μl or more, including all decimal fractions in between to 0.1 decimal points, as described elsewhere herein.

### Devices, Systems and Kits

A device as described herein comprises a hollow tube or container, generally with two open ends. A first open end is configured to receive a sample and a second open end is configured to be attached to a suction device. The application of suction to the second end (to a volume of the tube) causes a liquid to be drawn into the tube via the first end if/when the first open end is submerged into a source of liquid. Alternatively, capillary action may be the force that drives ingress of liquids into the tube.

The tube that contains the sensing oil and the sample can be made of any plastic, glass, quartz, ceramic, or rubber materials that are transparent or translucent, so that color changes or other optical property changes can be detected through the material of which the tube is made. The tube can be of any shape or size to match the volume of the sensing oil and sample. In some aspects, the tube is a pipette tube, a capillary tube or a microfabricated channel.

In some aspects, the tube of the device is preloaded e.g., by applying suction to the second open end so that the sensing oil is taken up into the tube, and the liquid source is switched to dilution buffer and dilution buffer is taken up into the tube. This pattern results in a tube loaded as depicted in the top panel of FIG. 2A. Other sequences of loading are also encompassed, e.g., dilution buffer and then sensing oil (top panel of FIG. 2B), or sensing oil then dilution buffer then sensing oil again (top panel of FIG. 2C). Thus, as provided to the user, the tube is generally preloaded with a tube comprising an aliquot (segment or segments) of sensing oil tube and an aliquot (segment) of dilution buffer, each with a total volume of a few μL. Thus, when the tube is a pipette tip, the dilution buffer may be at the proximal (first) end of the pipette tip to directly contact the sample (Format 1) or in the middle of the sensing oil (Format 3) or at the distal (second) end of the pipette tip (Format 2). Upon mixing, the dilution buffer is mixed with the sample regardless of the original position. When the dilution buffer is sealed by the sensing oil from both sides (Format 3), its evaporation during storage is prevented because the oil has a very high boiling point and evaporates very slowly. In other formats, one side of the tube is sealed by other means to prevent evaporation of the dilution buffer during storage. The sealing method is via any plug or cap that fits at least one end of the tube. The plug or cap can be removed by the user prior to the use of the tube for chemical measurements. A tape may also be used to seal at least one end of the tube and be removed by the user. A drop of liquid polymer or polymer precursor may also be added to at least one end of the tube and be solidified to create a seal. The solidified polymer chunk can be removed by the user when its adhesion to the tube is designed to be weak. One example of the sealing material is wax, which is liquid at high temperatures and become solidified rapidly at room temperature on top of an end of a capillary tube. The piece of wax can be removed manually from the end of the tube.

However, other aspects are also contemplated, e.g., the user is provided with a clean (empty) tube and instructions regarding how to load the sensing oil, dilution buffer and sample, amounts of both of which are provided with the device; or only the sensing oil is preloaded and the user loads both the sample and dilution buffer (dilution buffer is provided with the device) and directions regarding how to obtain and dilute the sample in the dilution buffer and load the same, etc. Additionally, in some aspects, the dilution buffer is not used and analytes in the sample are detected by the sensing oil without dilution.

Examples of tubes that are suitable for use in the device include but are not limited to: a pipette tip, a capillary tube, or any device with a hollow channel, e.g., a microfabricated channel. The volume of the tube is generally in the range of from about 10 μL to about 10 mL. Multibore tubing can also be used to hold different sensing oils in different lumens of the tube. One end of multiple lumens is connected to the device of suction and another end of multiple lumens can be exposed to the sample so that the sample is introduced into multiple lumens.

Generally, the tubes are designed to be disposable, although washable, reusable tubes are not excluded. In this case, a washing and/or rinsing solution may also be provided to the user, e.g., in a kit, together with the tubes and one or more other items described below.

Systems comprising the device disclosed herein are also provided. The systems comprise at least a tube as described above and a source of suction. Examples of suitable sources of suction include but are not limited to: a stepper motor-based device such as an electronic pipette or syringe pump. The source of suction may also control the mixing of two phases to facilitate extraction of the analyte from the sample to the sensing oil.

Further items for inclusion in a system, which may be part of a “kit” that is provided to the user or may use one or more components otherwise available to the user, include but are not limited to: a means for detecting a color change in the sensing oil of the device and a means of analyzing the color change, or a means which does both, i.e., which both detects and analyzes color changes, or a means for detecting the absorbance of the oil, or a means for detecting the fluorescence of the oil. Monochrome cameras are usually more suited to fluorescence imaging. They do not have a color filter array, allowing more photons to reach the photosensitive sensor and increasing their sensitivity.

Detecting a color change refers to detecting a change in color of the sensing oil, for example, by comparing the color before and after mixing with the sample and/or comparing the color to standards, threshold values and/or ranges of analyte concentration, etc. Detection may be accomplished in comparison to standards such as sensing oils comprising known amounts of an analyte of interest, sensing oil without any analyte present, and other standards that will occur to those of skill in the art. In some aspects, it may be sufficient to simply detect a change and describe a sample as positive or negative for the presence of an analyte of interest. In some aspects, a color chart (either digital or a “hard copy” on paper) with each color indicating an analyte concentration is provided to allow users to correlate the color obtained for their samples and the analyte concentration. In this case, the color change may be detected “by eye” by the user. In other aspects, it is preferable to analyze a color change in detail, e.g., to detect a quantity, amount or level of change, and or to detect the hue, intensity or shade of color, and to interpret/analyze the color change and/or the degree of color change. This analysis generally involves “capturing” a representation of the sensing oil after mixing (and optionally also before mixing), such as obtaining a digital image (photograph) of the oil phase segment of the tube which is then compared to one or more corresponding standards. It is noted that standards may be predetermined and provided to the user (e.g., via a computer-based medium in a reader device described below) or may be established by the user following instructions provided with the device. Digital representations are obtained, e.g., with a smart phone camera, a digital camera, etc., which the user may already have. Alternatively, a digital device (e.g., a small digital camera) to capture the representation may be specifically designed for inclusion in e.g., a kit comprising the device described herein.

In some aspects described in more detail below, the means of interpreting a digital representation comprises a computer program such as a mobile “app”. Color analyzing apps are known and may be downloaded from the internet to a device such as a portable smart phone, i-pad, personal computer, laptop, etc., and access to the digital representation is also provided on the device. Commercially available apps that fulfil this function include but are not limited to: apps such as Color Mate, Color Grab, ColorSnap® Visualizer, Google Lens, Palette Cam, Color Converter, Adobe Capture, Color Viewfinder, Pantone Studio, Coolors, TECHKON ColorCatcher, etc. Alternatively, an app or other type of program may be designed specifically for use in analyzing the results (color changes) obtained by practicing the methods disclosed herein. Further, a device for capturing and analyzing color changes may be designed specifically for use in the methods disclosed herein, e.g., a camera with a built-in or preloaded or preprogrammed analysis system.

Output from the analysis means is provided to the user and/or to suitable medical professionals by any of a variety of methods. For example, a visual output may be provided to a screen and may include a numerical read-out, a graph, etc. which shows the measurement just taken in comparison to a standard or standards and/or in comparison to previous results and/or in comparison to goals, etc. A range indicator may be included, e.g., “high”, “low”, “normal”, etc. The output may be in black and white or in color.

The app or computer program may be set to automatically transfer the results of the analysis to a suitable medical professional for analysis by a human or AI, e.g., by a smartphone. Feedback may be provided to the user, such as instructions to increase or decrease a dose of medication, contact the medical provider, or “good job; continue with present dosing”, etc. Further, reminders to perform the assay may be built-in as may recognition that an analysis has been completed.

The means for detecting and/or analyzing and/or transferring color change data may be referred to herein as a reader device. Examples of reader devices include, but are not limited to, personal electronic devices such as cell phones, smart phones, personal digital assistants (PDAs), tablet computers, laptop computers, media players, and other such devices. In particular embodiments, a reader device or a component thereof (e.g., image capture device 499) may be a mobile electronic device.

A reader device may be a single device or, alternatively, a reader device may include two or more devices communicatively coupled. Therefore, in some embodiments, a “reader device” may include two or more electronic devices, and operations described and attributed herein to a reader device may be performed collectively by the two or more electronic devices.

In some embodiments, a reader device can include both a personal electronic device and an image capture device such as a camera. In various embodiments, the image capture device may be configured to communicate data to a mobile electronic device such as a smartphone or a cell phone, or to another type of electronic device. The image capture device and the personal electronic device may each be configured to perform some of the reader device functions described herein. For example, an image capture device may include one or more of a processor, an optical sensor, a memory, and a communications module (e.g., a transmitter, transceiver, or other type of communications device) coupled by circuitry. Optionally, image capture device may include a power source (e.g., a rechargeable battery or a replaceable battery).

The reader device may comprise or use an imaging application that includes one or more algorithms for color analysis, calculation of representative values for analytes, tracking of representative values over time, analysis of a user's medication, and/or other functions. For example, the imaging application may include an algorithm configured to analyze the effect of a user's medication based on user inputs (e.g., times and dosages at which a medication was taken) and the determined concentrations of an analyte of interest at particular time points. Optionally, the imaging application may track the effect of the medication as a function of dosage and/or time or suggest modifications in the dosage of the medication based on the analysis.

The reader device may be configured to access a look-up table from program data or a database that stores one or more of a pre-determined pattern, reference images, calibration data, and/or ranges for some or all of the analytes of interest. The reader device may then determine or calculate a representative value for an analyte based on the image color data and corresponding detection ranges.

The concentrations/representative values, captured image, image data, and/or other relevant data (e.g., time, date, identity of analyte, etc.) may be stored in non-volatile memory as program data or imaging data. The reader device may track the concentrations/representative values over time, recording them in a table or other format that can be displayed or communicated to the user. Optionally, the reader device may display the captured image and/or determined representative value on a display, communicate the results to the user or to another device/system, and/or generate and communicate a message, notification, alert, instructions, or a representative value (e.g., a target analyte concentration) to a user of the reader device in a visual, audio, and/or tactile (e.g., vibratory) format. Optionally, the reader device may alert the user of a possible device malfunction, or that the device is approaching or has reached or exceeded the end of its recommended duration of use.

In some embodiments, the reader device may transmit a message, notification, alert, instructions, or a representative value (e.g., a target analyte concentration) to a medical service provider or caretaker. The reader device may be communicatively coupled to one or more computing devices or systems via a wireless connection or network. The reader device may exchange data with one or more of a personal computer, a network, a medical device, a first computing system, a first database, a second computing system, and/or a second database. In some examples, the first computing system/database is a medical provider or health monitoring computing system/database and may be operated or accessible by a first medical provider, such as a primary care physician of the user. The second computing system/database may be operated by a caretaker or a second medical provider such as a doctor's office, hospital, emergency medical service, or subscription-based service that notifies a medical provider of a potential emergency. Alternatively, the second computing system/database may be a computing system/database of a manufacturer that can be read by reader device. The computing system of the manufacturer may analyze and/or track data received from the reader device to assess device performance.

In some embodiments, an analyte sensor may be read by a user without the use of a reader device. For example, the user may determine an approximate analyte concentration by viewing the color changes within the tube without the aid of a reader device. Optionally, the user may be provided with a visual aid such as a chart, color key, or the like. The user may compare the response(s) of the analysis region(s) to the chart to determine an approximate analyte concentration. Alternatively, the user may interpret the response(s) of the analysis region(s) without the use of a visual aid. For example, after a period of time, the user may have sufficient experience with the use of the sensor to correlate the visible color change to an approximate analyte concentration.

In addition, although the reader device is typically used to capture images of the sensor, one or more of the other functions described herein as being performed by the reader device may instead be performed by another device or system, such as a computer, database, medical device, etc., and vice versa. For example, the reader device may capture an image of the sensor and transmit the image data to a computing system for analysis. Alternatively, image analysis functions may be divided among the reader device and another device or computing system. For example, the reader device may be configured to determine a representative value for a target analyte and the computing system may be configured to track the representative values over time and/or to generate and send instructions to the reader device to adjust one or more operational parameters.

Calculating a representative value may include comparing the representative value to one or more reference values. Some reference values may be pre-determined such as color changes corresponding to specific concentrations of an analyte.

An imaging application is one example of an application suitable for use with the present analyte monitoring system. As used herein, the term “imaging application” refers to a program that directs a processor to perform various tasks related to analyte monitoring (e.g., image analysis, calibration, tracking of data, etc.). Imaging applications and operations thereof may vary among embodiments. Optionally, an imaging application may include, or may be provided with, reference data such as reference tables/values, reference images, and/or other relevant data. Some imaging applications may be developed or configured for use with a particular type of reader device (e.g., a smartphone or tablet computer) and/or operating system (e.g., Google Android, Apple iOS, Nokia Symbian, RIM BlackBerry OS, Samsung Bada, Microsoft Windows Phone, Hewlett-Packard webOS, Linux operating system). Again, these examples are provided merely by way of illustration, and imaging applications may be configured/adapted/developed for use with many other types of reader devices (e.g., tablet computer, personal digital assistant, camera) and/or operating systems. Some imaging applications may be “cross-platform” applications developed or configured for use with multiple types of reader devices/operating systems. In some embodiments, a reader device may an iPhone or an iPad.

In some embodiments, an imaging application may be pre-installed on the reader device (e.g., by the reader device manufacturer). In other embodiments, the application may be provided in a physical medium, such as an optical disc (e.g., a CD, a DVD), a data storage disk (e.g., a ZIP disk), a flash memory device (e.g., a USB flash drive, a memory card), and the like. Alternatively, the application may be downloaded/electronically transmitted to the reader device or associated computer system (e.g., the user's personal computer) over a network (e.g., the Internet). The application may be made available for download from a computer system or database of a third party (e.g., a manufacturer of the service, a manufacturer of the reader device, a medical service provider, a software developer, a software distributor, or a web-based application store, such as the Apple App Store). In some embodiments, the imaging application may be a web-based application that resides on a server of a third party and is accessible by the reader device via the Internet (e.g., as a web application). In one example, a portion of the web-based imaging application may be downloaded to the reader device and may reside on the reader device thereafter. Alternatively, a portion of the imaging application may be downloaded to the reader device each time the reader device accesses/uses the imaging application.

Various operations, sequential orders in which operations are performed, and the distribution of operations among the reader device and other devices/computing systems may vary among embodiments. For example, in some embodiments, one or more of the operations may be performed locally by the reader device and others may be performed remotely by one or more third-party computer systems. A third-party computer system can be a computer system, website, database, server (e.g., a network server, a cloud server), or other digital distribution platform of a third party such as a manufacturer, a medical services provider, and/or an imaging application developer. Again, many variations and modifications to the illustrated processes and user interface displays will be readily understood by persons with ordinary skill in the art in light of the present disclosure, which encompasses all such variations and modifications.

In various embodiments, one or more of the user interface displays may be included in the device or system, and they may comprise additional user-selectable features (e.g., virtual buttons or keys, links, etc.) configured to provide control over, or access to, various options/displays of the imaging application.

The reader device may be calibrated based at least in part on the reference measurement(s). The calibration process may be performed by the reader device, a third-party computing system, and/or both. In some embodiments, the reader device and/or third-party computing system may track reference measurement inputs as part of the calibration process. The reader device may track reference measurement inputs and/or associated data over a period of days, weeks, months, or years. In some embodiments, the reader device may periodically transmit the reference measurement inputs and/or associated data to a third-party computing device. This may allow the reader device to store a smaller volume of tracking data in local storage. In some embodiments, tracking data may be accessed/downloaded by the reader device from the third-party computing system (e.g., analyte sensor manufacturer, cloud network, etc.) in response to a request from the user for such data.

The reader device may report one or more data trends to the user. For example, the reader device may report data trends to the user as a function of time (e.g., over a day, week, month, year, etc.) in the form of a dashboard, chart, table, or other format.

### Methods

Provided herein are methods of detecting (measuring, analyzing, assaying, etc.) the amount (level, concentration, moles, etc.) of analyte in a sample.

In some aspects, the methods comprise a step of obtaining a sample that is suitable for analysis. Exemplary samples are listed elsewhere herein and include samples from the body of an animal such as a mammal, or samples of interest such as water, samples from plants, etc.

The step of obtaining a sample is conducted by any suitable means, depending on the nature of the sample and the setting for using the devices and methods. For example, if the sample is a blood sample and the analysis is being conducted in the home or other non-laboratory setting by a patient, blood may be obtained e.g., by a finger prick conducted by the patient. Similarly, the patient may obtain saliva samples using a swab which is then placed in a buffered solution from which an aliquot is taken. Saliva samples may also be collected in a collection tube without dilution. If the sample is urine, a small amount may be obtained in a container and diluted, or not, for analysis. Other techniques for sample procurance by non-professional subjects are known and any technique that is suitable for the type of sample may be used. Depending on the nature of the sample, the sample may or may not be diluted prior to introducing it into the tube of the device, e.g., using a suitable amount of diluent such as an aqueous buffer, generally a physiologically comparable buffer, examples of which include water, saline, phosphate buffer, etc. and others as described elsewhere herein for the dilution buffer. Such buffers may be provided to the patient along with the device, e.g., as part of a kit.

If the methods are used in a professional setting, then other options are available for obtaining a sample, such as using needles to pierce the skin, a blood vessel, an internal organ, etc. to retrieve a sample of interest. If the samples are not physiological, and method that provides a suitable amount of sample may be used, e.g., a pipette, syringe, etc.

To practice the methods, the user (patient, subject, etc.) aspirates or draws up a drop or aliquot of sample into the tube via the suction source, the tube having been preloaded with sensing oil and optionally dilution buffer. Generally, the suction source is preprogrammed or “preset” to transfer a given amount of sample.

The sensing oil and the diluted or undiluted sample need to be in contact so that the analyte can be at least partially or preferably fully extracted from the sample into the sensing oil. The two phases may be mixed by a process such as vortexing, spinning, shaking, vibrating, stirring, or via an oscillating pressure source (e.g., vacuum or suction) that moves these two liquid phases back and forth.

Generally, a stepper-motor-powered vacuum (suction) source, which is usually supplied with the device, is used. Examples of the stepper motor include but are not limited to syringe pumps and electronic pipettes.

Typically, the suction source is also preprogrammed or “preset” to cause the contents of the tube to be automatically drawn up and then mixed or agitated by rapidly “pulling” and “pushing” the contents back and forth until the phases are thoroughly mixed. During mixing, the two phases intermingle and analytes of interest come into contact with the sensing molecules in the sensing oil and are captured, i.e., they are bound to the sensing molecules and thus stay in the sensing oil. In other words, mass transfer of the analyte between the sensing oil and the dilution buffer occurs via a mixing protocol. The analyte in the aqueous samples is fully or partially extracted into the oil phase during the mixing process.

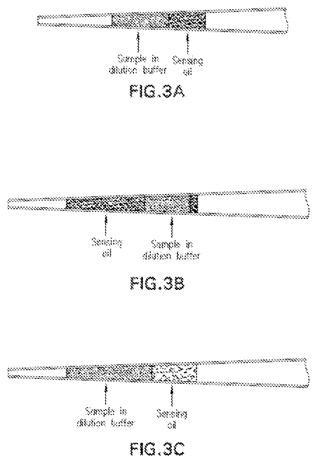

The mixing process includes multiple, alternate pushing and pulling cycles to move liquids in the tube (see FIG. 3A) in one first direction and then in the opposite second direction. Pushing steps move or propel liquids in the tube toward the first (proximal) end of the tube i.e., away from the motor, but without expelling liquid from the proximal tip of the tube. Pulling steps pull liquids in the tube toward the second (distal) end of the tube, i.e., toward the motor. The liquids move over the same travel distance in both directions but generally do so at unequal speeds. In an exemplary protocol, in a first set of e.g., 10 cycles of pulls-pushes, the pulling speed is about 1 to 15 times higher than the pushing speed, e.g., about 1, 2, 3, 4, 5, 6, 7, 8, 9, 10, 11, 12, 13, 14 or 15 times higher. After this first set, the oil segment is at the proximal end of the tube (further from the stepper motor; see FIG. 3B). Then the speed of pushing and pulling is switched for another (second) set of e.g., 10 cycles of mixing in which the pushing speed is greater e.g., about 1 to 15 times higher than the pulling speed e.g., about 1, 2, 3, 4, 5, 6, 7, 8, 9, 10, 11, 12, 13, 14 or 15 times higher. During this second set, the position of the oil is gradually switched (changed, shifted) so as to be at the distal end of the tube (closer to the stepper motor; see FIG. 3C) at the end of the second set. Alternating the relative positions of the sensing oil and the aqueous sample greatly enhances the mass transfer between the two immiscible phases and reduces the response time of the sensor. This position alternating process controlled by an unequal moving speed may be repeated multiple times to reach an equilibrium response, for example, from about 1-100 times, such as about 1, 10, 20, 30, 40, 50, 60, 70, 80, 90, or 100 times or more. The travel distance in the push and pull steps is preferably greater than the length of the total liquid in the tube to achieve the shortest response time but is shorter than (less than) the total length of the tube. For example, when about 10 μl of sensing oil and about 10 μl of aqueous phase are present in a pipette tip using Format 1, the length of the segment of sensing oil is about 3-5 mm and the length of the segment of aqueous phase is about 3-5 mm, and the travel distance in the push and pull steps is preferably greater than the combined distance, i.e., greater than about 6-10 mm. The length of the liquid depends on the exact position of the liquid in the tube and the diameter and/or shape of the tube.

While the mixing protocol is typically preprogrammed, in some aspects, the user may perform the mixing protocol by following instructions provided e.g., in a kit. For example, the instructions may instruct the user to “agitate the contents of the tube up and down for a minimum of 25 strokes” or “for 20 seconds”, for example.

The optical signal of the oil phase and/or the sample phase, preferably the optical property of the oil phase instead of the sample, is detected by, for example, a color detector or fluorescence detector that is located at the site of use of the device. Alternatively, a representation of the tube after mixing is obtained and provided to a computer-based analysis program such as an app that is employed by the user. In this aspect, the color change of the oil segment is typically recorded by a camera. Thus, after mixing, the user obtains a digital image (e.g., takes a photograph) of at least the oil segment of the tube. A digital image of the entire tube may be obtained since only the sensing oil changes color. Then, the digital image is loaded, transferred to, or otherwise made accessible to the app or other program which analyzes the color changes and provides an output to the user and/or optionally to at least one suitable medical professional. In some aspects, a camera associated with a smart-phone or i-pad is used. In other aspects, a separate digital or monochrome camera is used.

In some aspects, the digital representation is sent (uploaded) e.g. to a website for analysis and processing. Remote exchange, processing, monitoring, storing, etc. of data is well known. Data are obtained, analyzed, transformed and output is provided to a user e.g., as described in United States patent applications 20220192609, 20190197858, 20130303869 and 20190361436, the complete contents of each of which is hereby incorporated by reference in entirety, i.e., via Internet of Things (IoT) connections.

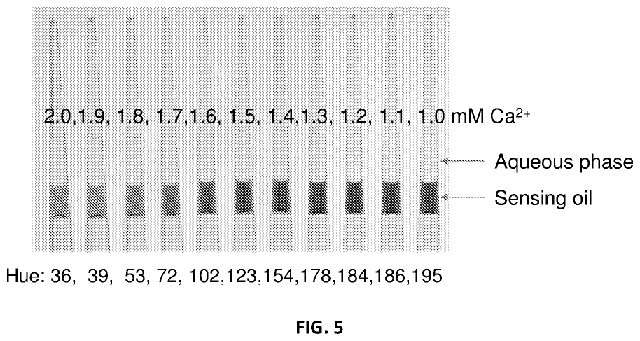

FIG. 5 shows the color change of an oil segment in response to different concentrations of CaCl₂) in a pH 7.4 buffer. Standard solutions with known concentrations of Ca²⁺ are used to construct a calibration curve (the oil color parameter as a function of the analyte concentration in the aqueous phase). When the sample is an unknown sample, the oil color is obtained and used to calculate the analyte concentration. The color parameter can be hue or any other color or fluorescence parameter, e.g., fluorescence intensity and peak wavelength.

It is to be understood that this invention is not limited to particular embodiments described, as such may, of course, vary. It is also to be understood that the terminology used herein is for the purpose of describing particular embodiments only and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLES

### Example 1. Response of a Calcium Ionophore-Based Sensor to Ca²⁺

A E1-ClipTip™ Electronic Pipette from ThermoFisher Scientific was used to aspirate liquids including sensing oil, dilution buffer, and standard solution or blood into 30 μL ClipTip™ pipette tips. Then liquids in the pipette tip were mixed by repeated aspiration and pipetting steps with appropriate speeds. After a certain number of mixing steps, an iPhone 13 Mini was used to take photos of the liquids in the pipette tips. The position of the iPhone was fixed by a yAyusi overhead phone mount purchased from Amazon, while a rectangular LED light box was underneath the pipette tips. The color of each oil segment was analyzed by an iPhone Color Mate app, and the hue of each color was obtained from the app for quantitative analysis.

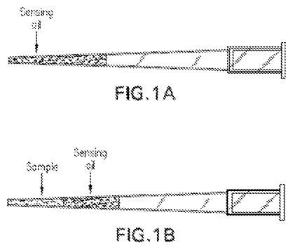

Dioctyl sebacate (DOS) is a commonly used plasticizer in ion-selective optodes. Without using an extra solvent like tetrahydrofuran, we directly dissolved hydrophobic sensing chemicals including chromoionophore III, ion exchanger (sodium tetrakis[3,5-bis(trifluoromethyl)phenyl]borate), and calcium ionophore II (molar ratio: 0.35:1:6) in DOS to form the sensing oil. The optode sensor (FIG. 1A) was created by aspirating 7.5 μL of the sensing oil into a plastic pipette tip connected to an Electronic Pipette. Then 2.5 μL of aqueous solution containing Ca²⁺ was aspirated into the pipette tip (FIG. 1B). The liquid is aspirated into the pipette direction for about 3 mm so that no liquid is too close to the tip and causes a risk of fluid loss. After a customized multi-step aspirating and pipetting protocol, photos of the pipette tips were taken (FIG. 5), and the color of the oil segment was analyzed by Color Mate. In the mixing protocol, 10 cycles of aspirating and pipetting was first performed with an aspirating speed of 3 and a pipetting speed of 7, resulting in an aqueous segment closer to the pipette. Then 10 more cycles of aspirating and pipetting were performed with an aspirating speed of 7 and a pipetting speed of 3, resulting in an oil segment closer to the pipette. These 20 cycles comprise a mixing step and such mixing step was repeated for 7 more times before the equilibrium response was obtained and photos were taken.

The results showed that the sensing oil had different colors after being exposed to standard aqueous solutions containing different concentrations of Ca²⁺. This color change establishes the correlation between the oil color and the Ca²⁺ concentration, allowing for colorimetric determination of Ca²⁺ concentration in unknown samples such as blood samples.

### Example 2. Analysis of Ca²⁺ in Blood

A human blood sample containing Ca²⁺ was analyzed as follows. A pipette tip was preloaded with 7.5 μL of the sensing oil and 5.0 μL of HEPES buffer. A drop of blood with a volume of 2.5 μL was aspirated into the pipette tube and thus came into contact with the HEPES buffer. Then the mixing protocol (8 rounds, each round compromises 20 cycles of pipetting and aspirating) described in example 1 was used to allow mass transfer between two phases to occur. Then a photo of the pipette tip was taken and the color of the oil segment was analyzed.

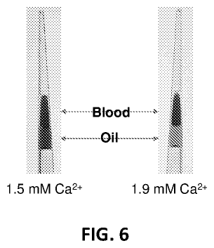

The results are shown in FIG. 6, which shows the color change in the sensing oil phase after mixing with a sample of blood obtained as described above. As can be seen, the color of the oil changed depending on the Ca²⁺ concentration in blood. The concentration of Ca²⁺ in blood determined by a commercial calcium test kit (Pointe Scientific Calcium (Arsenazo III) Reagents) matched the concentration determined by the sensing oil in the pipette tip after hematocrit correction.

### Example 3. Response of a Colorimetric Potassium Ionophore-Based Sensor to K⁺

When the sensing oil contains chromoionophore III, sodium tetrakis[3,5-bis(trifluoromethyl)phenyl]borate, and potassium ionophore I (valinomycin) at a molar ratio of 0.43:1:3 was exposed to aqueous solutions containing 3-7 mM KCl and underwent the mixing protocol described in Example 1, the oil color was different for different concentrations of K⁺. The volume of sensing oil and aqueous solution was 7.5 and 2.5 μL, respectively. The result is shown in FIG. 7. This sensor can be used to determine the concentration of K⁺ in unknown samples.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A system for detecting one or more analytes in a sample, comprising:
a tube or container in which the sample may be added, wherein the tube is configured to permit application of a suction within a volume defined by the tube or container;
a sensing oil that is within or addable to the tube or container, wherein the sensing oil is immiscible with the sample;
at least one molecule that selectively binds to at least one analyte, wherein the at least one molecule is dissolved or dispersed in the sensing oil, and, optionally,
a buffer that is within or addable to the tube or container, wherein the buffer is miscible with the sample.

2. The system of claim 1 further comprising at least one reporter molecule dissolved or dispersed in the oil, wherein the at least one reporter molecule is activated by the at least one molecule selectively binding to the at least one analyte in the sample.

3. The system of claim 1 further comprising a suction source connectable to the tube or container.

4. A device for detecting at least one analyte in a sample, comprising
a tube comprising,
a first open end that is configured to receive a sample;
a second open end that is configured to be attached to a source of suction;
a sensing oil that is immiscible with the sample and which comprises at least one sensing molecule that binds to the at least one analyte, and, optionally,
i) at least one optical reporter molecule, and/or
ii) at least one ion exchanger;
and
a source of suction configured to attach to the second open end of the tube.

5. The device of claim 4, further comprising dilution buffer.

6. The device of claim 4, wherein the tube is a pipette tip, a capillary tube, or a microfabricated channel.

7. The device of claim 5, wherein a volume of the dilution buffer ranges from 0.1 μl to 10 ml.

8. The device of claim 4, wherein a volume of the oil phase ranges from 0.1 I to 10 ml.

9. The device of claim 4, wherein the at least one sensing molecule is an ionophore or comprises an ion recognition unit.

10. The device of claim 4, wherein the at least one optical reporter molecule is a pH indicator or a cationic dye.

11. The device of claim 4, wherein the at least one ion exchanger is a tetraphenylborate derivative or a quaternary ammonium compound.

12. A system comprising
the device of claim 4;
a source of suction; and
a reader device configured to detect the color, absorbance, or fluorescence of the sensing oil and determine a concentration of the at least one analyte based on the color, absorbance, or fluorescence of the sensing oil.

13. The system of claim 12, wherein the source of suction is a stepper motor-based device.

14. The system of claim 12, wherein the stepper motor-based device is an electronic pipette or a syringe pump.

15. The system of claim 12, wherein the reader device is a camera, photometer, spectrophotometer or fluorometer.

16. The system of claim 15, wherein the camera is a part of a mobile electronic device selected from the group consisting of a cell phone, a smart phone, a personal computer, and a personal digital assistant.

17. The system of claim 12, further comprising a light source configured to illuminate the tube.

18. A method of detecting at least one analyte in a sample, comprising
aspirating the sample into the tube of claim 12,
within the tube, mixing the sample with the sensing oil according to a protocol that permits the at least one analyte to partition into the sensing oil and bind to the at least one sensing molecule; and
detecting an optical property change that occurs in the at least one sensing molecule or, optionally, in the at least one optical reporter molecule, upon binding of the at least one analyte to the at least one sensing molecule.

19. The method of claim 18, wherein the optical property change indicates a quantity of the at least one analyte bound to the at least one sensing molecule.

20. The method of claim 18, wherein the sample is a biological sample.

21. The method of claim 20, wherein the biological sample is blood, tears, sweat, saliva, urine, interstitial fluid, cerebrospinal fluid, milk, serum or plasma.

22. The method of claim 18, wherein the water-immiscible oil is one or more of a plasticizer and a plant oil.

23. The method of claim 18, wherein the at least one sensing molecule is an ionophore or comprises an ion recognition unit.

24. The method of claim 18, wherein the mixing protocol comprises a plurality of cycles of pushing and pulling the liquid in the tube.

25. The method of claim 24, wherein the plurality of cycles of pushing and pulling ranges from 1 to 5000.

26. The method of claim 18, wherein the reporter molecule is a chemical with absorbance or fluorescence in the UV-visible range.

27. The method of claim 18, wherein the at least one analyte is an ion or a small molecule.

28. The method of claim 27, where the ion is at least one of a proton, K⁺, Na⁺, Li⁺, Ca²⁺, Mg²⁺, Pb²⁺, Cd²⁺, Cu²⁺, Cr²⁺, Ag⁺, Hg²⁺, Zn²⁺, Cl⁻, SO₄²⁻, CO₃²⁻, nitrate, nitrite, creatinine, and a drug that is ionic at the applied pH.
